(19) United States
(12) Patent Application Publication
(10) Pub. No.: US 2024/0206667 A1
(43) Pub. Date: Jun. 27, 2024

(54) Steam Cooker Assembly

(71) Applicants: Armando Alcaraz, Orange, CA (US); Denise Moore, Orange, CA (US); Tim Moore, Orange, CA (US)

(72) Inventors: Armando Alcaraz, Orange, CA (US); Denise Moore, Orange, CA (US); Tim Moore, Orange, CA (US)

(21) Appl. No.: 18/086,271

(22) Filed: Dec. 21, 2022

(51) Int. Cl. A47J 27/04

(52) U.S. Cl. CPC A47J 27/04; A47J 2027/043

(57) ABSTRACT

A steam cooker assembly includes a cooking pot having a cooking chamber positioned above a fluid reservoir facilitating steam from a boiling fluid in the fluid reservoir to pass upwardly through the cooking chamber. A lid is positionable on the cooking pot to retain the steam within the cooking pot. A fill pipe is attached to the cooking pot thereby facilitating fluid to be added to the fluid reservoir without removing the lid from the cooking pot. A basket is positionable within the cooking pot and a plurality of steam tubes is each positionable in the basket thereby facilitating the steam from the boiling fluid to rise upwardly through the steam tubes. A plurality of disks is provided and each of the steam tubes is extendable through the disks facilitating each of the disks to support a food item to cook the food item with the steam.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to cooking devices and more particularly pertains to a new cooking device for steam cooking tamales. The device includes a cooking pot that has a fluid reservoir and a cooking chamber. The device includes a lid for closing the cooking pot and a fill pipe attached to the cooking pot for filling the fluid reservoir without removing the lid. The device includes a foraminous basket that is positionable in the cooking pot, plurality of foraminous steam tubes positionable in the foraminous basket and a plurality of disks that are positionable on the steam tubes for supporting tamales for steaming the tamales.

### (2) Description of Related Art Including Information Disclosed Under 37 CFR 1.97 and 1.98

The prior art relates to cooking devices including a steamer pot that includes a cooking pot, a steamer basket and a lid. The prior art discloses a food steamer that includes a cooking pot and a stirring mechanism. The prior art discloses a food steamer that includes a housing, a water tank removably positionable in the housing and a plurality of steaming trays that can be nested in the housing. The prior art discloses a cooking system that includes a pot, a reversible lid which is foraminous for employing as a colander, steamer and strainer. The prior art discloses a variety of steamer devices that at least includes a steamer pot and window integrated into the steamer pot for viewing a level of fluid in the steamer pot.

### (h) BRIEF SUMMARY OF THE INVENTION

An embodiment of the disclosure meets the needs presented above by generally comprising a cooking pot that has a cooking chamber positioned above a fluid reservoir thereby facilitating steam from a boiling fluid in the fluid reservoir to pass upwardly through the cooking chamber when the cooking pot is placed on a heat source. A lid is positionable on the cooking pot to retain the steam within the cooking pot. A fill pipe is attached to the cooking pot thereby facilitating fluid to be added to the fluid reservoir without removing the lid from the cooking pot. A basket is positionable within the cooking pot and a plurality of steam tubes is each positionable in the basket thereby facilitating the steam from the boiling fluid to rise upwardly through the steam tubes. A plurality of disks is provided and each of the steam tubes is extendable through the disks thereby facilitating each of the disks to support a food item to cook the food item with the steam.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a steam cooker assembly according to an embodiment of the disclosure.

FIG. 2 is a perspective exploded view of an embodiment of the disclosure.

FIG. 3 is a top exploded view of an embodiment of the disclosure.

FIG. 4 is an exploded view of a plurality of steam tubes and a plurality of disks of an embodiment of the disclosure.

FIG. 5 is a cross sectional view taken along line 5-5 of FIG. 1 of an embodiment of the disclosure.

FIG. 6 is a front view of an embodiment of the disclosure.

### (j) DETAILED DESCRIPTION OF THE INVENTION

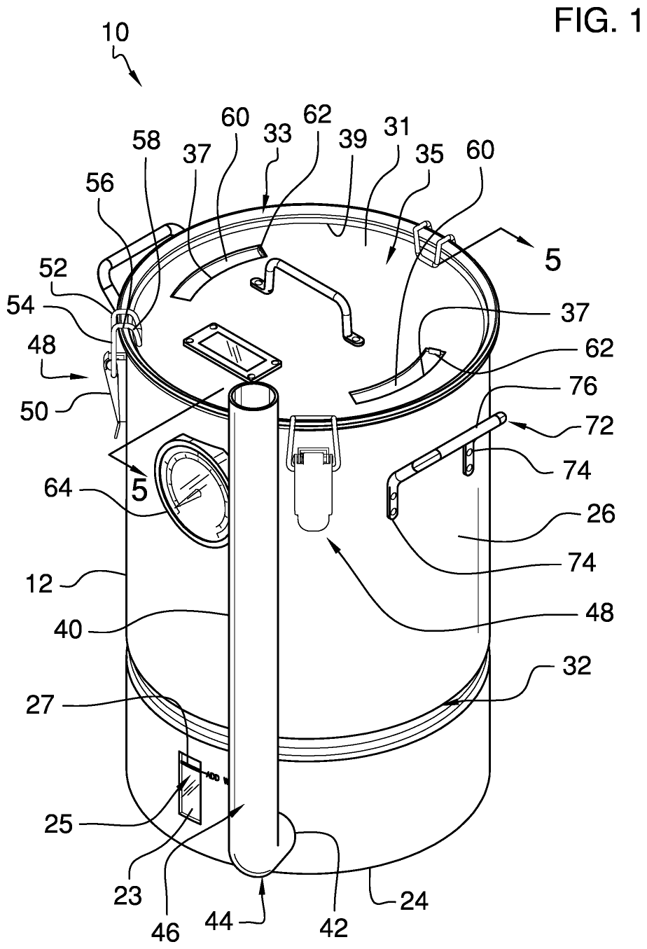

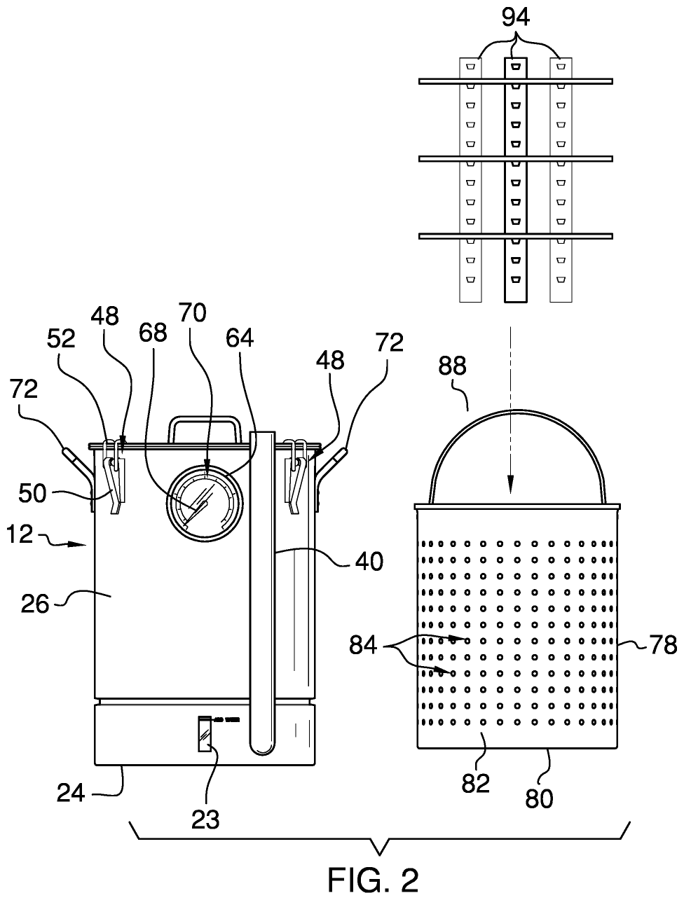

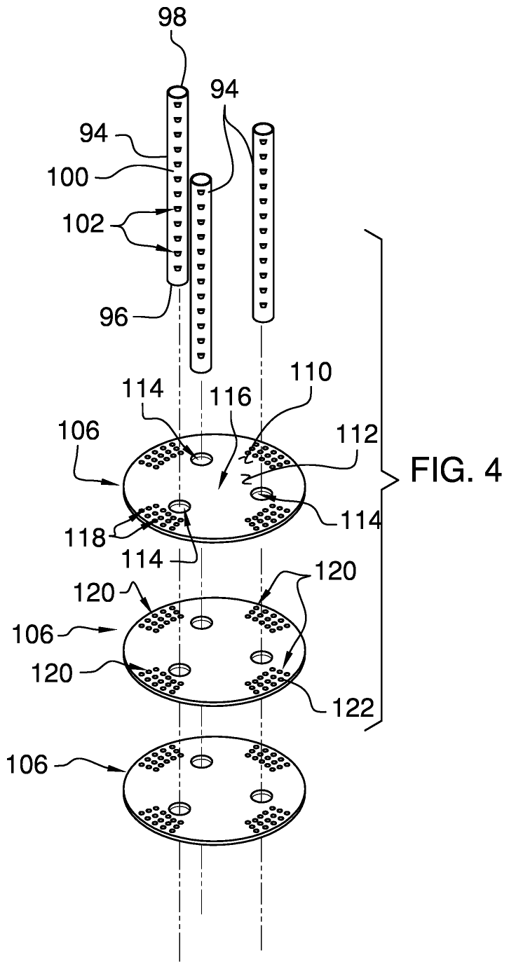

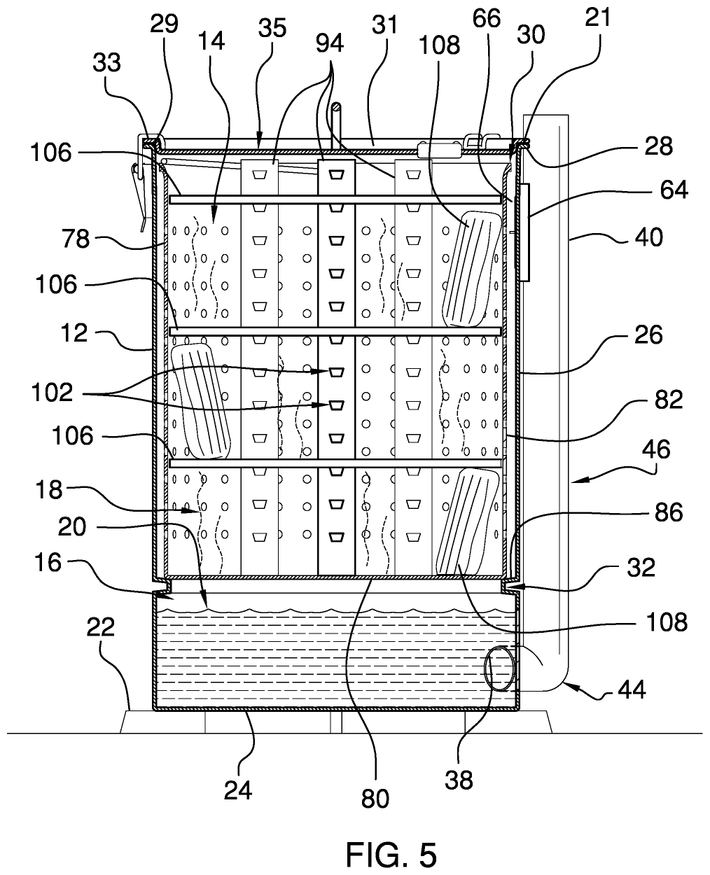

With reference now to the drawings, and in particular to FIGS. 1 through 6 thereof, a new cooking device embodying the principles and concepts of an embodiment of the disclosure and generally designated by the reference numeral 10 will be described.

As best illustrated in FIGS. 1 through 6, the steam cooker assembly 10 generally comprises a cooking pot 12 that has a cooking chamber 14 positioned above a fluid reservoir 16 thereby facilitating steam 18 from a boiling fluid 20 in the fluid reservoir 16 to pass upwardly through the cooking chamber 14 when the cooking pot 12 is placed on a heat source 22. The boiling fluid 20 may comprise water that has been heated to the boiling point of the water. The cooking pot 12 has a basal wall 24 and an outer wall 26 extending upwardly from the basal wall 24 and the outer wall 26 has a top edge 28 defining an opening 30 into the cooking pot 12. The outer wall 26 has a crease 32 extending around a full circumference of the outer wall 26 thereby defining the fluid reservoir 16 below the crease 32 and defining the cooking chamber 14 above the crease 32. Furthermore, the crease 32 is positioned closer to the basal wall 24 than the top edge 28.

The cooking pot 12 is comprised of a thermally conductive material thereby facilitating the cooking pot 12 to be heated by the heat source 22 for boiling the fluid 20 in the fluid reservoir 16. The thermally conductive material may comprise steel, aluminum or other type of rigid material commonly employed for cooking pots. The cooking pot 12 has a viewing window 23 that is integrated into the outer wall 26 and the viewing window 23 is aligned with the fluid reservoir 16 thereby facilitating a fluid 20 level in the fluid reservoir 16 to be visually identified. The viewing window 23 has indicia 25 applied to the viewing window 23 comprising a fill line 27 extending laterally across the viewing window 23 thereby facilitating the indicia 25 to visually indentify when fluid 20 needs to be added to the fluid reservoir 16. The outer wall 26 has a bend 29 extending around a full circumference of the outer wall 26 to define a lip 21 extending laterally away from the outer wall 26 and the bend 29 is spaced from the top edge 28.

A lid 31 is positionable on the cooking pot 12 for closing the cooking pot 12 to retain the steam 18 within the cooking pot 12. The lid 31 has a raised ring 33 lying on a plane that is oriented parallel with a middle 35 of the lid 31. The raised ring 33 rests on the lip 21 defined in the outer wall 26 of the cooking pot 12 when the lid 31 is positioned on the cooking pot 12. The lid 31 has a pair of steam openings 37 each extending through the middle 35 of the lid 31 to pass steam 18 outwardly through the lid 31. Each of the steam openings 37 is elongated and is structured to be co-arcuate with a threshold 39 between the middle 35 of the lid 31 and the raised ring 33.

The outer wall 26 has a fill opening 38 extending into the fluid reservoir 16 and the fill opening 38 is positioned between the crease 32 and the basal wall 24 to facilitate the fluid reservoir 16 to be filled with the fluid 20. A fill pipe 40 is attached to the cooking pot 12 such that the fill pipe 40 is in fluid communication with the fluid reservoir 16 thereby facilitating fluid 20 to be added to the fluid reservoir 16 without removing the lid 31 from the cooking pot 12. The fill pipe 40 has a coupled end 42 that is coupled to the outer wall 26 of the cooking pot 12 having the coupled end 42 being aligned with the fill opening 38. The fill pipe 40 has a bend 44 that is spaced from the outer wall 26 to define an upright section 46 of the fill pipe 40 extending upwardly along the outer wall 26.

A plurality of clamps 48 is provided and each of the clamps 48 is movably attached to the cooking pot 12. Each of the clamps 48 releasably engages the lid 31 when the lid 31 is positioned on the cooking pot 12 and the clamps 48 are positioned in a closed condition for retaining the lid 31 on the cooking pot 12. Each of the clamps 48 includes a lever 50 that is pivotally disposed on the outer wall 26 of the cooking pot 12 at a point spaced downwardly from the lip 21. Each of the clamps 48 includes a grapple 52 that is pivotally attached to the lever 50 which includes a first member 54 extending upwardly from the lever 50, a second member 56 that is perpendicularly oriented with the first member 54 and a third member 58 angling downwardly from the second member 56. The second member 56 extends over the raised ring 33 on the lid 31 having the third member 58 extending downwardly to abut the middle 35 of the lid 31 when the grapple 52 is positioned in a gripping position. The grapple 52 is urged downwardly when the lever 50 is pivoted into a clamping position thereby compressing the lid 31 onto the cooking pot 12. Additionally, the grapple 52 is released from the lid 31 when the lever 50 is pivoted in a releasing position thereby facilitating the lid 31 to be removed from the cooking pot 12.

A pair of closures 60 is each slidably integrated into the lid 31 and each of the closures 60 is aligned with a respective one of the steam openings 37 in the lid 31. Each of the closures 60 is positionable to cover an adjustable length of the respective steam 18 opening to adjust the amount of steam 18 that is released from the respective steam 18 opening. Each of the closures 60 has a tab 62 extending upwardly out of the respective steam 18 opening thereby facilitating the tab 62 to be gripped for manipulating the closures 60.

A temperature gauge 64 is attached to the outer wall 26 of the cooking pot 12 and the temperature gauge 64 has a temperature probe 66 extending through the outer wall 26 such that the temperature probe 66 is in thermal communication with an interior of the cooking pot 12. The temperature gauge 64 includes an indicator 68 that is in communication with the temperature probe 66 such that the indicator 68 visually communicates the temperature sensed by the temperature probe 66. The temperature gauge 64 has temperature indicia 70 that are applied to a front face of the temperature gauge 64 comprising a graduated scale for indicating the temperature sensed by the temperature probe 66 in degrees.

A pair of handles 72 is each attached to and angles away from the cooking pot 12. Each of the handles 72 has a pair of outward members 74 each angling away from the outer wall 26 of the cooking pot 12. Additionally, each of the handles 72 has a central member 76 extending between the outward members 74 such that the central member 76 is spaced from the outer wall 26 thereby facilitating the central member 76 of each of the handles 72 to be gripped. Each of the handles 72 is positioned on opposite sides of the cooking pot 12 with respect to each other.

A basket 78 is provided and the basket 78 is positionable within the cooking pot 12. The basket 78 is foraminous thereby facilitating the steam 18 from the boiling fluid 20 to pass through the basket 78. The basket 78 has a bottom wall 80 and an exterior wall 82 extending upwardly from the bottom wall 80 and each of the bottom wall 80 and the exterior wall 82 is perforated with a plurality of holes 84 thereby facilitating the basket 78 to be foraminous. The bottom wall 80 rests on a top wall 86 of the crease 32 when the basket 78 is positioned within the cooking pot 12 such that the basket 78 is positioned in the cooking chamber 14 in the cooking pot 12. A wire 88 is provided that is curved between a first end 90 and a second end 92 of the wire 88. Each of the first end 90 and the second end 92 pivotally engages the exterior wall 82 of the basket 78 thereby facilitating the wire 88 to be gripped for lower or lifting the basket 78 into or out of the cooking pot 12.

A plurality of steam tubes 94 is each positionable in the basket 78 when the basket 78 is positioned in the cooking pot 12 thereby facilitating the steam 18 from the boiling fluid 20 to rise upwardly through the steam tubes 94. Each of the steam tubes 94 is perforated thereby facilitating the steam 18 to pass through the steam tubes 94 to evenly distribute the steam 18 within the cooking pot 12. Each of the steam tubes 94 has a lower end 96, an upper end 98 and an exterior wall 100 extending between the lower end 96 and the upper end 98. Each of the steam tubes 94 has a plurality of vents 102 each extending through the exterior wall 100 of the steam tubes 94 and the vents 102 in each of the steam tubes 94 are spaced apart from each other and are distributed between the lower end 96 and the upper end 98 of the steam tubes 94. The lower end 96 of each of the steam tubes 94 rests on the bottom wall 80 of the basket 78 when the steam tubes 94 are positioned in the basket 78.

A plurality of disks 106 is provided and each of the steam tubes 94 is extendable through the disks 106 thereby facilitating each of the disks 106 to support a food item 108 to cook the food item 108 with the steam 18. The food item 108 may be a tamale, for example, or other type of food item that is traditionally cooked with steam from boiling water. Each of the disks 106 is perforated thereby facilitating the steam 18 to pass through the disks 106 and each of the disks 106 has an upper surface 110 and a lower surface 112. Each of the disks 106 has a plurality of steam tube holes 114 each extending through the upper surface 110 and the lower surface 112 thereby facilitating each of the steam tubes 94 to be extended through a respective one of the steam tube holes 114. The steam tube holes 114 in each of the disks 106 are spaced apart from each other and are distributed around a center 116 of a respective one of the disks 106. Each of disks 106 has a plurality of steam holes 118 each extending through the upper surface 110 and the lower surface 112 and the steam holes 118 in each of the disks 106 is arranged in a plurality of sets of steam holes 120. Each of the sets of steam holes 120 in a respective one of the disks 106 is positioned adjacent to a perimeter edge 122 of the respective disk 106. The plurality of sets of steam holes 120 in the respective disk 106 is spaced apart from each other and distributed around the perimeter edge 122 of the respective disk 106.

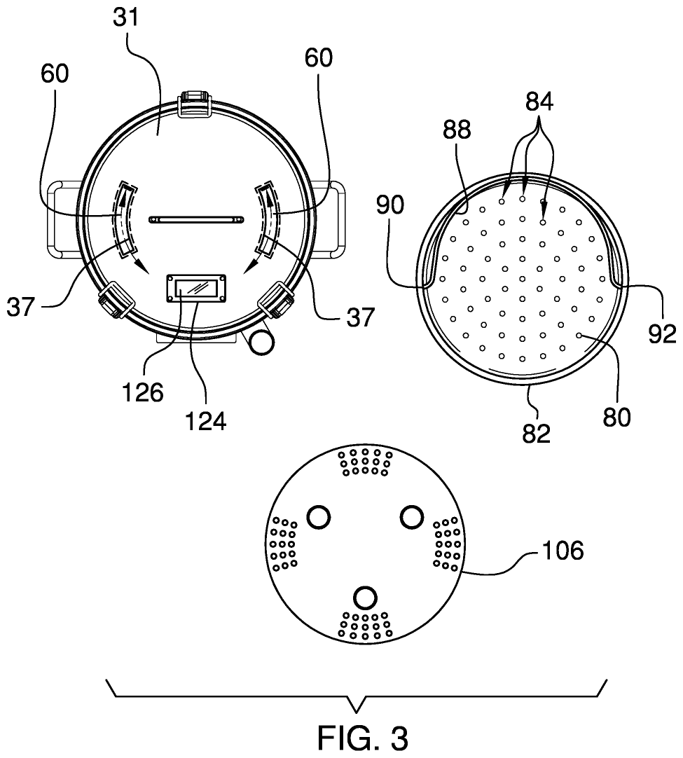

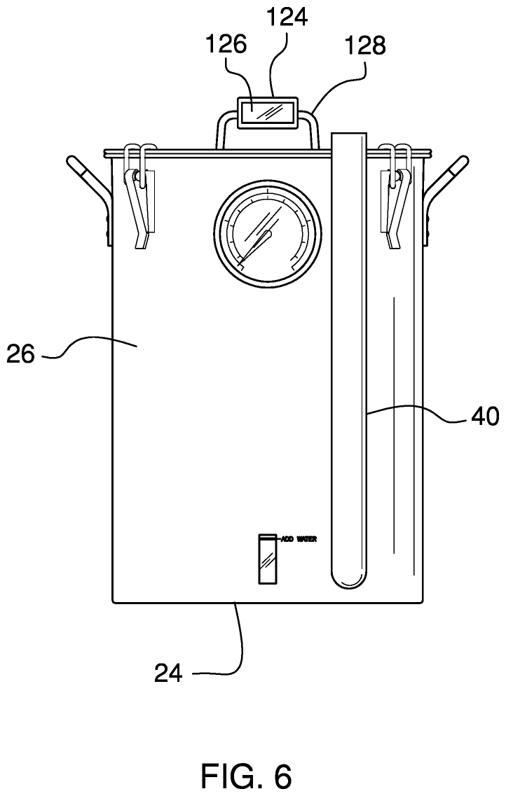

An electronic timer 124 is attached to the lid 31 and the electronic timer 124 includes a display 126 which displays numbers for tracking the duration of time the food items 108 have been cooked. As is most clearly shown in FIG. 3, the electronic timer 124 may be positioned on the middle 35 of the lid 31. As is most clearly shown in FIG. 6, the electronic timer 124 may be attached to a handle 128 that is disposed on the middle 35 of the lid 31.

In use, the fluid 20 is poured into the fill pipe 40 to fill the fluid reservoir 16 with the fluid 20 and the cooking pot 12 is placed on the heat source 22, such as kitchen stove, to boil the fluid 20 in the fluid reservoir 16 to produce steam 18. The steam tubes 94 and are positioned in the basket 78, food items 108 are positioned on respective disks 106 and the basket 78 is lowered into the cooking pot 12. The lid 31 is positioned on the cooking pot 12 and each of the clamps 48 is manipulated to lock the lid 31 onto the cooking pot 12. Additionally, each of the closures 60 is positioned to facilitate a desired amount of steam 18 to escape through the steam openings 37 in the lid 31. Additional fluid 20 can be poured into the fill pipe 40 to replenish the fluid 20 while the food items 108 are being steamed when the viewing window 23 indicates that the fluid 20 level has fallen below the fill line 27. In this way the internal temperature of the cooking pot 12 can be maintained while the additional fluid 20 is poured into the fill pipe 40.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A steam cooker assembly for cooking food products with steam, said assembly comprising:
a cooking pot having a cooking chamber being positioned above a fluid reservoir thereby facilitating steam from a boiling fluid in said fluid reservoir to pass upwardly through said cooking chamber when said cooking pot is placed on a heat source;
a lid being positionable on said cooking pot for closing said cooking pot wherein said lid is configured to retain the steam within said cooking pot;
a fill pipe being attached to said cooking pot such that said fill pipe is in fluid communication with said fluid reservoir thereby facilitating fluid to be added to said fluid reservoir without removing said lid from said cooking pot;
a plurality of clamps, each of said clamps being movably attached to said cooking pot, each of said clamps releasably engaging said lid when said lid is positioned on said cooking pot and said clamps are positioned in a closed condition for retaining said lid on said cooking pot;
a pair of handles, each of said handles being attached to and angling away from said cooking pot;
a basket being positionable within said cooking pot, said basket being foraminous thereby facilitating the steam from the boiling fluid to pass through said basket;
a plurality of steam tubes, each of said steam tubes being positionable in said basket when said basket is positioned in said cooking pot thereby facilitating the steam from the boiling fluid to rise upwardly through said steam tubes, each of said steam tubes being perforated thereby facilitating the steam to pass through said steam tubes wherein said steam tubes are configured to evenly distribute the steam within said cooking pot; and
a plurality of disks, each of said steam tubes being extendable through said disks thereby facilitating each of said disks to support a food item to cook the food item with the steam, each of said disks being perforated thereby facilitating the steam to pass through said disks.

2. The assembly according to claim 1, wherein said cooking pot has a basal wall and an outer wall extending upwardly from said basal wall, said outer wall having a top edge defining an opening into said cooking pot, said outer wall having a crease extending around a full circumference of said outer wall thereby defining said fluid reservoir below said crease and defining said cooking chamber above said crease, said crease being positioned closer to said basal wall than said top edge, said cooking pot being comprised of a thermally conductive material thereby facilitating said cooking pot to be heated by the heat source for boiling the fluid in said fluid reservoir, said outer wall having a bend extending around a full circumference of said outer wall to define a lip extending laterally away from said outer wall, said bend being spaced from said top edge.

3. The assembly according to claim 2, wherein said cooking pot has a viewing window being integrated into said outer wall, said viewing window being aligned with said fluid reservoir thereby facilitating a fluid level in said fluid reservoir to be visually identified, said viewing window having indicia being applied to said viewing window comprising a fill line extending laterally across said viewing window wherein said indicia are configured to visually indentify when fluid needs to be added to said fluid reservoir.

4. The assembly according to claim 2, wherein:
said outer wall has a fill opening extending into said fluid reservoir, said fill opening being positioned between said crease and said basal wall wherein said fill opening is configured to facilitate said fluid reservoir to be filled with the fluid; and
said fill pipe has a coupled end being coupled to said outer wall of said cooking pot having said coupled end being aligned with said fill opening, said fill pipe having a bend being spaced from said outer wall to define an upright section of said fill pipe extending upwardly along said outer wall.

5. The assembly according to claim 2, wherein said lid has a raised ring lying on a plane being oriented parallel with a middle of said lid, said raised ring resting on said lip defined in said outer wall of said cooking pot when said lid is positioned on said cooking pot, said lid having a pair of steam openings each extending through said middle of said lid wherein each of said steam openings is configured to pass steam outwardly through said lid, each of said steam openings being elongated and being structured to be co-arcuate with a threshold between said middle of said lid and said raised ring.

6. The assembly according to claim 5, wherein each of said clamps includes a lever being pivotally disposed on said outer wall of said cooking pot at a point spaced downwardly from said lip, each of said clamps including a grapple being pivotally attached to said lever which includes a first member extending upwardly from said lever and a second member being perpendicularly oriented with said first member and a third member angling downwardly from said second member such that said second member extends over said raised ring on said lid having said third member extending downwardly to abut said middle of said lid when said grapple is positioned in a gripping position, said grapple being urged downwardly when said lever is pivoted into a clamping position thereby compressing said lid onto said cooking pot, said grapple being released from said lid when said lever is pivoted in a releasing position thereby facilitating said lid to be removed from said cooking pot.

7. The assembly according to claim 5, further comprising a pair of closures, each of said closures being slidably integrated into said lid, each of said closures being aligned with a respective one of said steam openings in said lid, each of said closures being positionable to cover an adjustable length of said respective steam opening wherein each of said closures is configured to adjust the amount of steam that is released from said respective steam opening, each of said closures having a tab extending upwardly out of said respective steam opening thereby facilitating said tab to be gripped for manipulating said closures.

8. The assembly according to claim 2, further comprising a temperature gauge being attached to said outer wall of said cooking pot, said temperature gauge having a temperature probe extending through said outer wall such that said temperature probe is in thermal communication with an interior of said cooking pot, said temperature gauge including an indicator being in communication with said temperature probe such that said indicator visually communicates the temperature sensed by said temperature probe, said temperature gauge having temperature indicia being applied to a front face of said temperature gauge comprising a graduated scale for indicating the temperature sensed by said temperature probe in degrees.

9. The assembly according to claim 2, wherein:
said basket has a bottom wall and an exterior wall extending upwardly from said bottom wall, each of said bottom wall and said exterior wall being perforated with a plurality of holes thereby facilitating said basket to be foraminous, said bottom wall resting on a top wall of said crease when said basket is positioned within said cooking pot such that said basket is positioned in said cooking chamber in said cooking pot; and
said assembly includes a wire being curved between a first end and a second end of said wire, each of said first end and said second end pivotally engaging said exterior wall of said basket thereby facilitating said wire to be gripped for lifting or lowering said basket into or out of said cooking pot.

10. The assembly according to claim 9, wherein each of said steam tubes has a lower end, an upper end and an exterior wall extending between said lower end and said upper end, each of said steam tubes having a plurality of vents each extending through said exterior wall of said steam tubes, said vents in each of said steam tubes being spaced apart from each other and being distributed between said lower end and said upper end of said steam tubes, said lower end of each of said steam tubes resting on said bottom wall of said basket when said steam tubes are positioned in said basket.

11. The assembly according to claim 10, wherein:
each of said disks has an upper surface and a lower surface, each of said disks having a plurality of steam tube holes each extending through said upper surface and said lower surface thereby facilitating each of said steam tubes to be extended through a respective one of said steam tube holes, said steam tube holes in each of said disks being spaced apart from each other and being distributed around a center of a respective one of said disks; and
each of disks has a plurality of steam holes each extending through said upper surface and said lower surface, said steam holes in each of said disks being arranged in a plurality of sets of steam holes, each of said sets is steam holes in a respective one of said disks being positioned adjacent to a perimeter edge of said respective disk, said plurality of sets of steam holes in said respective disk being spaced apart from each other and being distributed around said perimeter edge of said respective disk.

12. A steam cooker assembly for cooking food products with steam, said assembly comprising:
a cooking pot having a cooking chamber being positioned above a fluid reservoir thereby facilitating steam from a boiling fluid in said fluid reservoir to pass upwardly through said cooking chamber when said cooking pot is placed on a heat source, said cooking pot having a basal wall and an outer wall extending upwardly from said basal wall, said outer wall having a top edge defining an opening into said cooking pot, said outer wall having a crease extending around a full circumference of said outer wall thereby defining said fluid reservoir below said crease and defining said cooking chamber above said crease, said crease being positioned closer to said basal wall than said top edge, said cooking pot being comprised of a thermally conductive material thereby facilitating said cooking pot to be heated by the heat source for boiling the fluid in said fluid reservoir, said cooking pot having a viewing window being integrated into said outer wall, said viewing window being aligned with said fluid reservoir thereby facilitating a fluid level in said fluid reservoir to be visually identified, said viewing window having indicia being applied to said viewing window comprising a fill line extending laterally across said viewing window wherein said indicia are configured to visually indentify when fluid needs to be added to said fluid reservoir, said outer wall having a bend extending around a full circumference of said outer wall to define a lip extending laterally away from said outer wall, said bend being spaced from said top edge, said outer wall having a fill opening extending into said fluid reservoir, said fill opening being positioned between said crease and said basal wall wherein said fill opening is configured to facilitate said fluid reservoir to be filled with the fluid;
a lid being positionable on said cooking pot for closing said cooking pot wherein said lid is configured to retain the steam within said cooking pot, said lid having a raised ring lying on a plane being oriented parallel with a middle of said lid, said raised ring resting on said lip defined in said outer wall of said cooking pot when said lid is positioned on said cooking pot, said lid having a pair of steam openings each extending through said middle of said lid wherein each of said steam openings is configured to pass steam outwardly through said lid, each of said steam openings being elongated and being structured to be co-arcuate with a threshold between said middle of said lid and said raised ring;
a fill pipe being attached to said cooking pot such that said fill pipe is in fluid communication with said fluid reservoir thereby facilitating fluid to be added to said fluid reservoir without removing said lid from said cooking pot, said fill pipe having a coupled end being coupled to said outer wall of said cooking pot having said coupled end being aligned with said fill opening, said fill pipe having a bend being spaced from said outer wall to define an upright section of said fill pipe extending upwardly along said outer wall;
a plurality of clamps, each of said clamps being movably attached to said cooking pot, each of said clamps releasably engaging said lid when said lid is positioned on said cooking pot and said clamps are positioned in a closed condition for retaining said lid on said cooking pot, each of said clamps including a lever being pivotally disposed on said outer wall of said cooking pot at a point spaced downwardly from said lip, each of said clamps including a grapple being pivotally attached to said lever which includes a first member extending upwardly from said lever and a second member being perpendicularly oriented with said first member and a third member angling downwardly from said second member such that said second member extends over said raised ring on said lid having said third member extending downwardly to abut said middle of said lid when said grapple is positioned in a gripping position, said grapple being urged downwardly when said lever is pivoted into a clamping position thereby compressing said lid onto said cooking pot, said grapple being released from said lid when said lever is pivoted in a releasing position thereby facilitating said lid to be removed from said cooking pot;
a pair of closures, each of said closures being slidably integrated into said lid, each of said closures being aligned with a respective one of said steam openings in said lid, each of said closures being positionable to cover an adjustable length of said respective steam opening wherein each of said closures is configured to adjust the amount of steam that is released from said respective steam opening, each of said closures having a tab extending upwardly out of said respective steam opening thereby facilitating said tab to be gripped for manipulating said closures;
a temperature gauge being attached to said outer wall of said cooking pot, said temperature gauge having a temperature probe extending through said outer wall such that said temperature probe is in thermal communication with an interior of said cooking pot, said temperature gauge including an indicator being in communication with said temperature probe such that said indicator visually communicates the temperature sensed by said temperature probe, said temperature gauge having temperature indicia being applied to a front face of said temperature gauge comprising a graduated scale for indicating the temperature sensed by said temperature probe in degrees;
a pair of handles, each of said handles being attached to and angling away from said cooking pot, each of said handles having a pair of outward members each angling away from said outer wall of said cooking pot, each of said handles having a central member extending between said outward members such that said central member is spaced from said outer wall thereby facilitating said central member of each of said handles to be gripped;
a basket being positionable within said cooking pot, said basket being foraminous thereby facilitating the steam from the boiling fluid to pass through said basket, said basket having a bottom wall and an exterior wall extending upwardly from said bottom wall, each of said bottom wall and said exterior wall being perforated with a plurality of holes thereby facilitating said basket to be foraminous, said bottom wall resting on a top wall of said crease when said basket is positioned within said cooking pot such that said basket is positioned in said cooking chamber in said cooking pot;
a wire being curved between a first end and a second end of said wire, each of said first end and said second end pivotally engaging said exterior wall of said basket thereby facilitating said wire to be gripped for lifting or lowering said basket into or out of said cooking pot;
a plurality of steam tubes, each of said steam tubes being positionable in said basket when said basket is positioned in said cooking pot thereby facilitating the steam from the boiling fluid to rise upwardly through said steam tubes, each of said steam tubes being perforated thereby facilitating the steam to pass through said steam tubes wherein said steam tubes are configured to evenly distribute the steam within said cooking pot, each of said steam tubes having a lower end, an upper end and an exterior wall extending between said lower end and said upper end, each of said steam tubes having a plurality of vents each extending through said exterior wall of said steam tubes, said vents in each of said steam tubes being spaced apart from each other and being distributed between said lower end and said upper end of said steam tubes, said lower end of each of said steam tubes resting on said bottom wall of said basket when said steam tubes are positioned in said basket; and
a plurality of disks, each of said steam tubes being extendable through said disks thereby facilitating each of said disks to support a food item to cook the food item with the steam, each of said disks being perforated thereby facilitating the steam to pass through said disks, each of said disks having an upper surface and a lower surface, each of said disks having a plurality of steam tube holes each extending through said upper surface and said lower surface thereby facilitating each of said steam tubes to be extended through a respective one of said steam tube holes, said steam tube holes in each of said disks being spaced apart from each other and being distributed around a center of a respective one of said disks, each of disks having a plurality of steam holes each extending through said upper surface and said lower surface, said steam holes in each of said disks being arranged in a plurality of sets of steam holes, each of said sets is steam holes in a respective one of said disks being positioned adjacent to a perimeter edge of said respective disk, said plurality of sets of steam holes in said respective disk being spaced apart from each other and being distributed around said perimeter edge of said respective disk.
